(19) United States
(12) Patent Application Publication
(10) Pub. No.: US 2023/0065149 A1
(43) Pub. Date: Mar. 2, 2023

(54) SCREEN-PRINTABLE IONOGEL ELECTROLYTES AND APPLICATIONS OF SAME

(71) Applicant: NORTHWESTERN UNIVERSITY, Evanston, IL (US)

(72) Inventors: Mark C. Hersam, Wilmette, IL (US); Woo Jin Hyun, Shantou (CN); Lindsay E. Chaney, Evanston, IL (US)

(21) Appl. No.: 17/968,180

(22) Filed: Oct. 18, 2022

Related U.S. Application Data
(63) Continuation-in-part of application No. 17/798,618, filed on Aug. 10, 2022.
Application No. 17/798,618 is a continuation-in-part of application No. PCT/US2021/052307, filed on Sep. 28, 2021.
(60) Provisional application No. 62/975,282, filed on Feb. 12, 2020.
(60) Provisional application No. 63/085,240, filed on Sep. 30, 2020.

(51) Int. Cl. H01M 10/0565; H01M 10/0525; H01M 10/0585; H01M 4/62

(52) U.S. Cl. CPC H01M 10/0565; H01M 10/0525; H01M 10/0585; H01M 4/625; H01M 4/623; H01M 2300/0082; H01M 2004/027

(57) ABSTRACT

One aspect of the invention relates to an ionogel electrolyte ink including an ionic liquid; and a gelling matrix material. The gelling matrix material is mixed with the ionic liquid in at least one solvent.

### CROSS-REFERENCE TO RELATED PATENT APPLICATIONS

This application is a continuation in part application of U.S. patent application Ser. No. 17/798,618, filed Aug. 10, 2022, which is a U.S. national stage entry of PCT Patent Application No. PCT/US2021/015375, filed Jan. 28, 2021, which itself claims priority to and the benefit of U.S. Provisional Patent Application No. 62/975,282, filed Feb. 12, 2020, which are incorporated herein in their entireties by reference.

This application is also a continuation in part application of PCT Patent Application No. PCT/US2021/052307, filed Sep. 28, 2021, which itself claims priority to and the benefit of U.S. Provisional Patent Application No. 63/085,240, filed Sep. 30, 2020, which are incorporated herein in their entireties by reference.

### STATEMENT AS TO RIGHTS UNDER FEDERALLY-SPONSORED RESEARCH

This invention was made with government support under grant number 70NANB19H005 awarded by the National Institute of Standards and Technology, and grant numbers CMMI-1727846, DMR-1720139 and DGE-1842165 awarded by the National Science Foundation. The government has certain rights in the invention.

### FIELD OF THE INVENTION

The present invention relates generally to materials, and more particularly to screen-printable ionogel electrolytes and applications of the same.

### BACKGROUND OF THE INVENTION

The background description provided herein is for the purpose of generally presenting the context of the invention. The subject matter discussed in the background of the invention section should not be assumed to be prior art merely as a result of its mention in the background of the invention section. Similarly, a problem mentioned in the background of the invention section or associated with the subject matter of the background of the invention section should not be assumed to have been previously recognized in the prior art. The subject matter in the background of the invention section merely represents different approaches, which in and of themselves may also be inventions. Work of the presently named inventors, to the extent it is described in the background of the invention section, as well as aspects of the description that may not otherwise qualify as prior art at the time of filing, are neither expressly nor impliedly admitted as prior art against the invention.

Considerable attention has recently been directed toward the development of solid-state electrolytes for lithium-ion batteries (LIBs). Solid-state electrolytes address safety concerns of conventional liquid electrolytes by eliminating highly flammable carbonate solvents, allowing continuous advances in LIB energy density. Moreover, solid-state electrolytes remove leakage issues and thus significantly reduce packaging constraints, facilitating LIB production in a diverse range of battery form factors. However, currently available solid-state electrolytes based on inorganics and polymers face major challenges for practical applications, including low ionic conductivity, high interfacial resistance, and cumbersome processing. Ionogel electrolytes, which are composite electrolytes based on ionic liquids and gelling solid matrices, have attracted significant interest due to their potential to overcome these challenges. In contrast to conventional liquid electrolytes, ionic liquids possess nonflammability, negligible vapor pressure, and high thermal stability. By blending ionic liquids with solid matrices, immobilization and gelation is induced, resulting in a mechanically flexible solid-state electrolyte. Ionogel electrolytes have been explored using a range of ionic liquids and solid matrices, achieving high ionic conductivity, wide electrochemical stability windows, favorable interfacial properties, and outstanding thermal stability. However, the development of ionogel electrolytes has typically focused on electrolyte properties, whereas less attention has been paid to their processing methods for practical production of LIBs, particularly using scalable additive manufacturing methods.

Printing processes offer significant benefits for LIB fabrication. For example, printing processes enable additive manufacturing of LIBs, which minimizes materials waste and thus results in higher sustainability and lower costs of production when compared to traditional coating processes. Moreover, printing processes are compatible with roll-to-roll production formats, which accelerates LIB production and consequently facilitates high-throughput manufacturing. To realize printable LIBs, various strategies have been explored, including inkjet, aerosol jet, screen, and three-dimensional printing. Among these printing methods, screen printing is particularly promising for LIB production due to its simplicity and scalability. Screen printing is an established printing method that deposits an ink through a screen mask composed of a mesh and patterned stencil. Screen-printable inks require optimized viscosities that are sufficiently low to allow the inks to pass through the screen mesh but also sufficiently high to minimize undesired ink spreading on the target substrate. For screen-printed LIBs, various electrode and electrolyte materials have been pursued, but screen-printable ionogel electrolytes have not yet been realized.

Therefore, a heretofore unaddressed need exists in the art to address the aforementioned deficiencies and inadequacies.

### SUMMARY OF THE INVENTION

In view of the foregoing, one of the objectives of this invention is to provide screen-printable ionogel electrolytes, and its applications.

In one aspect, the invention relates to an ionogel electrolyte ink, comprising an ionic liquid; and a gelling matrix material. The gelling matrix material is mixed with the ionic liquid in at least one solvent.

In one embodiment, a ratio of the gelling matrix material to the ionic liquid is about 1:2 by weight.

In one embodiment, a concentration of the gelling matrix material and the ionic liquid in the at least one solvent is about 600-900 mg mL⁻¹.

In one embodiment, the ionogel electrolyte ink has a viscosity that is tunable by a shear rate, wherein the ink viscosity decreases as the shear rate increases.

In one embodiment, the ink viscosity and the shear rate satisfy the relation of:

μ=Kγⁿ⁻¹

wherein μ and γ are the ink viscosity and the shear rate, respectively, n is a power law index of about 0.35, and K is a consistency index of about 44 Pa.

In one embodiment, the ionogel electrolyte ink has a storage modulus (G′) that is higher than its loss modulus (G″) with limited frequency and temperature dependence, revealing the reliable solid-like behavior of the ionogel electrolyte ink.

In one embodiment, the ionogel electrolyte ink has a mechanical moduli (G′) exceeding 1 MPa, and high ionic conductivities exceeding 1 mS cm⁻¹ at room temperature.

In one embodiment, the ionogel electrolyte ink has ionic conductivity that increases with temperature.

In one embodiment, the ionic liquid comprises 1-ethyl-3-methylimidazolium bis(trifluoromethylsulfonyl)imide (EMIM-TFSI), ammonium, imidazolium, pyrrolidinium, pyridinium, piperidinium, phosphonium, sulfonium-based ionic liquids, or a combination of them.

In one embodiment, the ionic liquid comprises 1-ethyl-3-methylimidazolium bis(trifluoromethylsulfonyl)imide (EMIM-TFSI).

In one embodiment, said EMIM-TFSI contains lithium bis(trifluoromethylsulfonyl)imide (LiTFSI) salt.

In one embodiment, the gelling matrix material comprises boron nitride nanosheets (BNNS), borocarbonitrides (BCN), oxide nanosheets, layered perovskites, hydroxide nanosheets including hydrotalcite-like layered double hydroxides, natural clays including bentonites and montmorillonites, or a combination of them.

In one embodiment, the BNNS comprises hexagonal boron nitride (hBN) nanoplatelets that are formed from bulk hBN microparticles by a liquid-phase exfoliation method.

In one embodiment, each exfoliated hBN nanoplatelet is coated with a thin amorphous carbon coating.

In one embodiment, the surface of each hBN nanoplatelet has oxidized carbonaceous residues following pyrolysis of stabilizing polymers by the liquid-phase exfoliation method, wherein the oxidized carbonaceous residues facilitate strong chemical interactions between the hBN nanoplatelets and the ionic liquid, thereby promoting strong gelation.

In one embodiment, oxide nanosheets comprises Al₂O₃, TiO₂ (anatase and rutile), ZrO₂, Nb₂O₅, HfO₂, CaCu₃Ti₄O₁₂, Pb(Zr,Ti)O₃, (Pb,La)(Zr,Ti)O₃, SiO₂, Al₂O₃, HfSiO₄, ZrO₂, HfO₂, Ta₂O₅, La₂O₃, LaAlO₃, Nb₂O₅, BaTiO₃, SrTiO₃, Ta₂O₅, or a combination of them.

In one embodiment, the at least one solvent comprises a single solvent including ethyl lactate, cyclohexanone, terpineol, ethylene glycol, ethanol, isopropanol, or butanone.

In one embodiment, the ionogel electrolyte ink is a screen-printable ionogel electrolyte ink.

In another aspect, the invention relates to an electrochemical device, comprising at least one component formed of the ionogel electrolyte ink as disclosed above.

In one embodiment, the electrochemical device further comprises a cathode, and an anode. The at least one component is disposed between the cathode and the anode. The at least one component comprises one or more ionogel electrolytes that are screen-printed of the ionogel electrolyte ink.

In one embodiment, the electrochemical device is one or more batteries, one or more supercapacitors, one or more transistors, one or more neuromorphic computing devices, one or more flexible electronics, one or more printed electronics, or any combination of them.

In one embodiment, the electrochemical device is a solid-state lithium-ion battery (LIB).

In one embodiment, the cathode comprises lithium nickel manganese cobalt oxides, lithium iron phosphate, lithium cobalt oxide, lithium nickel cobalt aluminum oxides, lithium manganese oxide, lithium nickel manganese oxide, lithium nickel oxide, or other electrochemically active cathode materials, and the anode comprises graphite, lithium titanate, Li₂TiSiO₅, silicon, germanium, tin, lithium metal, or other electrochemically active anode materials.

In one embodiment, the cathode comprises LiFePO₄ (LFP) screen-printed of an LEP ink on a first substrate; the anode comprises LTO screen-printed of an LTO ink on a second substrate; the one or more ionogel electrolytes comprise a first hBN ionogel electrolyte screen-printed on a top of the cathode to define a screen-printed LEP/ionogel structure, and a second hBN ionogel electrolyte screen-printed on a top of the anode to define a screen-printed LTO/ionogel structure; and the LIB is fabricated by sandwiching the screen-printed LFP/ionogel structure and the screen-printed LTO/ionogel structure.

In one embodiment, each of the LFP ink and the LTO ink comprises the active material of LFP or LTO, carbon black, and poly(vinylidene fluoride) dispersed in a solvent of 1-methyl-2-pyrrolidinone.

In one embodiment, each of the first and second hBN ionogel electrolytes has a thickness of 15 μm or larger.

In one embodiment, the LIB has a specific discharge capacity of 137 mAh g⁻¹ at 0.1 C, which remains higher than 100 mAh g⁻¹ at rates up to 0.5 C, at room temperature.

In one embodiment, the LIB has a specific discharge capacity of 141 mAh g⁻¹ at 0.1 C, which remains higher than 100 mAh g⁻¹ at rates up to 2 C, at about 60° C.

In one embodiment, the LIB has a capacity loss being less than 0.05% of an initial capacity per cycle for 300 cycles, and an average Coulombic efficiency for the 300 cycles exceeding 99.9%, at room temperature.

In one embodiment, the LIB has a capacity loss being less than 0.04% of an initial capacity per cycle for 500 cycles, and the average Coulombic efficiency for the 500 cycles exceeding 99.5%, at about 60° C.

In one embodiment, the LIB has mechanically deformable, bendable and/or flexible.

In one embodiment, the LIB maintains constant power output during repeated bending of the LIB regardless of the bending direction.

In one embodiment, the LIB has Nyquist plots with negligible or no change before, during and after bending, thereby implying that the hBN ionogel electrolytes allow stable bending deformation without compromising the interfaces between the screen-printed layers.

In one embodiment, the hBN ionogel electrolytes have the high mechanical modulus that provides resilience in the presence of external forces.

In one embodiment, the LIB exhibits no signs of failure or no noticeable changes in an open-circuit voltage (OCV) when a compressive force applied to the LIB is gradually raised to 500 N, thereby implying that the hBN ionogel electrolytes withstood the high pressure and thus inhibit the external forces from forming short circuits between the cathode and anode electrodes.

In one embodiment, the hBN ionogel electrolytes maintain the high mechanical moduli exceeding 1 MPa to temperatures as high as about 140° C.

In one embodiment, the LIB operates normally without voltage instabilities when a compressive force of 200 N is applied to the LIB on a hotplate at about 100° C.

These and other aspects of the present invention will become apparent from the following description of the preferred embodiment taken in conjunction with the following drawings, although variations and modifications therein may be affected without departing from the spirit and scope of the novel concepts of the disclosure.

### BRIEF DESCRIPTION OF THE DRAWINGS

The accompanying drawings illustrate one or more embodiments of the invention and together with the written description, serve to explain the principles of the invention. Wherever possible, the same reference numbers are used throughout the drawings to refer to the same or like elements of an embodiment.

FIG. 1 shows screen-printable hexagonal boron nitride (hBN) ionogel electrolytes according to embodiments of the invention. Panel (a): Scanning electron microscopy image of hBN nanoplatelets used as the gelling matrix for the ionogel electrolytes. Panel (b): X-ray photoelectron spectroscopy of the hBN nanoplatelets. Panel (c): Raman spectra of the hBN nanoplatelets. Panel (d): Photograph of the screen-printable hBN ionogel electrolyte ink. Panel (e): Shear viscosity of the screen-printable hBN ionogel electrolyte ink. Panel (f): Photograph of the screen-printed hBN ionogel electrolyte in a 2 cm×2 cm square pattern on an aluminum substrate.

FIG. 2 shows screen-printed electrodes and electrolytes according to embodiments of the invention. Panel (a): Schematic diagram for printing a LiFePO₄ (LFP) cathode and the hBN ionogel electrolyte on an aluminum substrate. Panel (b): Schematic diagram for printing a Li₄Ti₅O₁₂ (LTO) anode and the hBN ionogel electrolyte on an aluminum substrate. Photographs of an aluminum substrate after printing the LFP cathode in panel (c) and hBN ionogel electrolyte in panel (d). Photographs of an aluminum substrate after printing the LTO anode in panel (e) and hBN ionogel electrolyte in panel (f). Panel (g): Charge-discharge voltage profiles of half-cells using the printed LFP/hBN ionogel and LTO/hBN ionogel. The half-cells were measured at room temperature (RT) with a charge-discharge rate of 0.1 C.

FIG. 3 shows electrochemical performance of screen-printed LFP/LTO full-cells using the hBN ionogel electrolytes according to embodiments of the invention. Charge-discharge voltage profiles at room temperature in panel (a), and 60° C. in panel (b). Panel (c): Comparison of the rate capability at room temperature and 60° C. Panel (d): Cycling performance at room temperature with a charge-discharge rate of 0.3 C. Panel (e): Differential capacity (dQ/dV) curves at room temperature with a charge-discharge rate of 0.3 C. Panel (f): Cycling performance at 60° C. with a charge-discharge rate of 1 C. Panel (g): Differential capacity curves at 60° C. with a charge-discharge rate of 1 C.

FIG. 4 shows mechanical deformation testing of screen-printed LFP/LTO full-cells using the hBN ionogel electrolytes according to embodiments of the invention. Panel (a): Schematic for bending toward the cathode. Panel (c): Photograph of the screen-printed LIB powering a light-emitting diode during bending. Panel (c): Nyquist plots of the screen-printed LIB before/during bending and after 200 bending cycles. The 200 bending cycles include 100 bending cycles toward the cathode and 100 bending cycles toward the anode, with a bending radius (R) of 14 mm. Panel (d): Schematic for pressing the battery. Panel (e): Photograph of the screen-printed LIB while being pressed with a force over 500 N, showing an open-circuit voltage (OCV) of 1.884 V. Panel (f): OCV of the screen-printed LIB while pressing with forces ranging from 0 to 500 N five times. Panel (g): Schematic for pressing the screen-printed LIB on a hotplate. Panel (h): Photograph of the screen-printed LIB while being compressed with a force over 200 N on a hotplate at 100° C. Panel (i): charge-discharge voltage profiles of the screen-printed LIB while being compressed with a force over 200 N on a hotplate at 100° C.

FIG. 5 shows storage (G′) and loss (G″) moduli of the screen-printable hBN ionogel electrolyte as a function of frequency at 25° C. in panel (a), and G′ and G″ of the hBN ionogel electrolyte at elevated temperatures in panel (b).

FIG. 6 shows ionic conductivity of the screen-printable hBN ionogel electrolyte as a function of temperature.

FIG. 7 shows viscosity of the LiFePO₄ (LFP) and Li₄Ti₅O₁₂ (LTO) electrode inks as a function of shear rate at 25° C.

FIG. 8 shows schematic of the full-cell assembly. When the screen-printed LFP/ionogel was sandwiched with the screen-printed LTO/ionogel, a thin polymer film with an open square shape was inserted to prevent contacts between edges of the Al substrates. This film covered the substrate edges, but not the electrode area.

FIG. 9 shows charge-discharge voltage profiles of a screen-printed LFP/LTO full-cell with the hBN ionogel electrolyte during cycling at room temperature.

FIG. 10 shows charge-discharge voltage profiles of a screen-printed LFP/LTO full-cell with the hBN ionogel electrolyte during cycling at 60° C.

FIG. 11 shows photograph of a screen-printed LFP/LTO full-cell with the hBN ionogel electrolyte for mechanical tests, which was packaged using a plastic bag and vacuum sealer in panel (a), and photograph of the screen-printed LIB powering a light-emitting diode in panel (b).

FIG. 12 shows photograph of a screen-printed LFP/LTO full-cell with the hBN ionogel electrolyte, showing that it continues to power a light-emitting diode even while being folded in half.

### DETAILED DESCRIPTION OF THE INVENTION

The invention will now be described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

The terms used in this specification generally have their ordinary meanings in the art, within the context of the invention, and in the specific context where each term is used. Certain terms that are used to describe the invention are discussed below, or elsewhere in the specification, to provide additional guidance to the practitioner regarding the description of the invention. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way. Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and in no way limits the scope and meaning of the invention or of any exemplified term. Likewise, the invention is not limited to various embodiments given in this specification.

It will be understood that, as used in the description herein and throughout the claims that follow, the meaning of “a”, “an”, and “the” includes plural reference unless the context clearly dictates otherwise. Also, it will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the invention.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

It will be further understood that the terms “comprises” and/or “comprising,” or “includes” and/or “including” or “has” and/or “having”, or “carry” and/or “carrying,” or “contain” and/or “containing,” or “involve” and/or “involving, and the like are to be open-ended, i.e., to mean including but not limited to. When used in this disclosure, they specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

As used in this disclosure, “around”, “about”, “approximately” or “substantially” shall generally mean within 20 percent, preferably within 10 percent, and more preferably within 5 percent of a given value or range. Numerical quantities given herein are approximate, meaning that the term “around”, “about”, “approximately” or “substantially” can be inferred if not expressly stated.

As used in this disclosure, the phrase “at least one of A, B, and C” should be construed to mean a logical (A or B or C), using a non-exclusive logical OR. As used herein, the term “and/or” includes any and all combinations of one or more of the associated listed items.

Embodiments of the invention are illustrated in detail hereinafter with reference to accompanying drawings. The description below is merely illustrative in nature and is in no way intended to limit the invention, its application, or uses. The broad teachings of the invention can be implemented in a variety of forms. Therefore, while this invention includes particular examples, the true scope of the invention should not be so limited since other modifications will become apparent upon a study of the drawings, the specification, and the following claims. For purposes of clarity, the same reference numbers will be used in the drawings to identify similar elements. It should be understood that one or more steps within a method may be executed in different order (or concurrently) without altering the principles of the invention.

Ionogel electrolytes present several benefits for solid-state lithium-ion batteries including nonflammability, favorable electrochemical properties, and high thermal stability. However, limited processing methods are currently available for ionogel electrolytes, which restricts their practical applications.

One of the objectives of this invention is to provide a screen-printable ionogel electrolyte formulation/ink based on hexagonal boron nitride (hBN) nanoplatelets. To achieve screen-printable rheological properties, hBN nanoplatelets are mixed with an imidazolium ionic liquid in ethyl lactate. Following screen printing, the resulting spatially uniform and mechanically flexible hBN ionogel electrolytes achieve high room-temperature ionic conductivities greater than 1 mS cm⁻¹ and stiff mechanical moduli greater than 1 MPa. These hBN ionogel electrolytes enable the fabrication of fully screen-printed lithium-ion batteries with high cycling stability, rate performance, and mechanical resilience against flexion and external forces, thus providing a robust energy storage solution that is compatible with scalable additive manufacturing.

Specifically, in one aspect of the invention, the ionogel electrolyte ink comprises an ionic liquid; and a gelling matrix material. The gelling matrix material is mixed with the ionic liquid in at least one solvent. In some embodiments, a ratio of the gelling matrix material to the ionic liquid is about 1:2 by weight. In some embodiments, a concentration of the gelling matrix material and the ionic liquid in the at least one solvent is about 600-900 mg mL⁻¹.

In some embodiments, the ionogel electrolyte ink has a viscosity that is tunable by a shear rate, wherein the ink viscosity decreases as the shear rate increases. In some embodiments, the ink viscosity and the shear rate satisfy the relation of:

μ=Kγⁿ⁻¹

wherein μ and γ are the ink viscosity and the shear rate, respectively, n is a power law index of about 0.35, and K is a consistency index of about 44 Pa.

In some embodiments, the ionogel electrolyte ink has a storage modulus (G′) that is higher than its loss modulus (G″) with limited frequency and temperature dependence, revealing the reliable solid-like behavior of the ionogel electrolyte ink. In some embodiments, the ionogel electrolyte ink has a mechanical moduli (G′) exceeding 1 MPa, and high ionic conductivities exceeding 1 mS cm⁻¹ at room temperature.

In some embodiments, the ionogel electrolyte ink has ionic conductivity that increases with temperature.

In some embodiments, the ionic liquid comprises 1-ethyl-3-methylimidazolium bis(trifluoromethylsulfonyl)imide (EMIM-TFSI), ammonium, imidazolium, pyrrolidinium, pyridinium, piperidinium, phosphonium, sulfonium-based ionic liquids, or a combination of them.

In some embodiments, the ionic liquid comprises 1-ethyl-3-methylimidazolium bis(trifluoromethylsulfonyl)imide (EMIM-TFSI). In some embodiments, said EMIM-TFSI contains lithium bis(trifluoromethylsulfonyl)imide (LiTFSI) salt.

In some embodiments, the gelling matrix material comprises boron nitride nanosheets (BNNS), borocarbonitrides (BCN), oxide nanosheets, layered perovskites, hydroxide nanosheets including hydrotalcite-like layered double hydroxides, natural clays including bentonites and montmorillonites, or a combination of them.

In some embodiments, the BNNS comprises hexagonal boron nitride (hBN) nanoplatelets that are formed from bulk hBN microparticles by a liquid-phase exfoliation method.

In some embodiments, each exfoliated hBN nanoplatelet is coated with a thin amorphous carbon coating. In some embodiments, the surface of each hBN nanoplatelet has oxidized carbonaceous residues following pyrolysis of stabilizing polymers by the liquid-phase exfoliation method, wherein the oxidized carbonaceous residues facilitate strong chemical interactions between the hBN nanoplatelets and the ionic liquid, thereby promoting strong gelation.

In some embodiments, oxide nanosheets comprises Al₂O₃, TiO₂ (anatase and rutile), ZrO₂, Nb₂O₅, HfO₂, CaCu₃Ti₄O₁₂, Pb(Zr,Ti)O₃, (Pb,La)(Zr,Ti)O₃, SiO₂, Al₂O₃, HfSiO₄, ZrO₂, HfO₂, Ta₂O₅, La₂O₃, LaAlO₃, Nb₂O₅, BaTiO₃, SrTiO₃, Ta₂O₅, or a combination of them.

In some embodiments, the at least one solvent comprises a single solvent including ethyl lactate, cyclohexanone, terpineol, ethylene glycol, ethanol, isopropanol, or butanone.

In some embodiments, the ionogel electrolyte ink is a screen-printable ionogel electrolyte ink.

In another aspect, the invention relates to an electrochemical device, comprising at least one component formed of the ionogel electrolyte ink as disclosed above.

In some embodiments, the electrochemical device further comprises a cathode, and an anode. The at least one component is disposed between the cathode and the anode. The at least one component comprises one or more ionogel electrolytes that are screen-printed of the ionogel electrolyte ink.

In some embodiments, the electrochemical device is one or more batteries, one or more supercapacitors, one or more transistors, one or more neuromorphic computing devices, one or more flexible electronics, one or more printed electronics, or any combination of them.

In some embodiments, the electrochemical device is a solid-state lithium-ion battery (LIB).

In some embodiments, the cathode comprises lithium nickel manganese cobalt oxides, lithium iron phosphate, lithium cobalt oxide, lithium nickel cobalt aluminum oxides, lithium manganese oxide, lithium nickel manganese oxide, lithium nickel oxide, or other electrochemically active cathode materials, and the anode comprises graphite, lithium titanate, Li₂TiSiO₅, silicon, germanium, tin, lithium metal, or other electrochemically active anode materials.

In some embodiments, the cathode comprises LiFePO₄ (LFP) screen-printed of an LEP ink on a first substrate; the anode comprises LTO screen-printed of an LTO ink on a second substrate; the one or more ionogel electrolytes comprise a first hBN ionogel electrolyte screen-printed on a top of the cathode to define a screen-printed LEP/ionogel structure, and a second hBN ionogel electrolyte screen-printed on a top of the anode to define a screen-printed LTO/ionogel structure; and the LIB is fabricated by sandwiching the screen-printed LFP/ionogel structure and the screen-printed LTO/ionogel structure. Each of the first and second substrates is an aluminum substrate or other electrically conductive substrate.

In some embodiments, each of the LFP ink and the LTO ink comprises the active material of LFP or LTO, carbon black, and poly(vinylidene fluoride) dispersed in a solvent of 1-methyl-2-pyrrolidinone. In some embodiments, a weight ratio of the active material of LFP or LTO, carbon black, and poly(vinylidene fluoride) is in a range of (8-9):(0.5-1):(0.5-1).

In some embodiments, each of the first and second hBN ionogel electrolytes has a thickness of 15 μm, or larger, e.g., 16 μm, 18 μm, etc.

In some embodiments, the LIB has a specific discharge capacity of 137 mAh g⁻¹ at 0.1 C, which remains higher than 100 mAh g⁻¹ at rates up to 0.5 C, at room temperature. In some embodiments, the LIB has a specific discharge capacity of 141 mAh g⁻¹ at 0.1 C, which remains higher than 100 mAh g⁻¹ at rates up to 2 C, at about 60° C.

In some embodiments, the LIB has a capacity loss being less than 0.05% of an initial capacity per cycle for 300 cycles, and an average Coulombic efficiency for the 300 cycles exceeding 99.9%, at room temperature. In some embodiments, the LIB has a capacity loss being less than 0.04% of an initial capacity per cycle for 500 cycles, and the average Coulombic efficiency for the 500 cycles exceeding 99.5%, at about 60° C.

In some embodiments, the LIB has mechanically deformable, bendable and/or flexible.

In some embodiments, the LIB maintains constant power output during repeated bending of the LIB regardless of the bending direction.

In some embodiments, the LIB has Nyquist plots with negligible or no change before, during and after bending, thereby implying that the hBN ionogel electrolytes allow stable bending deformation without compromising the interfaces between the screen-printed layers.

In some embodiments, the hBN ionogel electrolytes have the high mechanical modulus that provides resilience in the presence of external forces.

In some embodiments, the LIB exhibits no signs of failure or no noticeable changes in an open-circuit voltage (OCV) when a compressive force applied to the LIB is gradually raised to 500 N, thereby implying that the hBN ionogel electrolytes withstood the high pressure and thus inhibit the external forces from forming short circuits between the cathode and anode electrodes.

In some embodiments, the hBN ionogel electrolytes maintain the high mechanical moduli exceeding 1 MPa to temperatures as high as about 140° C.

In some embodiments, the LIB operates normally without voltage instabilities when a compressive force of 200 N is applied to the LIB on a hotplate at about 100° C.

The invention, among other things, has at least the following advantages over the existing technology.

Printability enables the sustainable production of electronic and energy storage devices with minimal materials waste and low cost, and also renders the device fabrication process compatible with roll-to-roll production schemes for high-throughput manufacturing. Among printing methods, screen printing is particularly promising due to its simplicity and scalability.

As a gelling matrix for ionogel electrolytes, hBN possesses several desirable attributes including electrically insulating properties, chemical inertness, thermal stability, and mechanical robustness. In addition, the nanoscale size and large surface area of exfoliated hBN nanoplatelets enable strong immobilization of ionic liquids without significant disruption of ion conduction pathways, yielding hBN ionogel electrolytes with high mechanical strength and ionic conductivity.

The ionogel electrolyte inks based on exfoliated hBN nanoplatelets exhibit shear thinning rheological properties, which are favorable for screen printing processes.

These and other aspects of the present invention are further described below. Without intent to limit the scope of the invention, exemplary instruments, apparatus, methods and their related results according to the embodiments of the present invention are given below. Note that titles or subtitles may be used in the examples for convenience of a reader, which in no way should limit the scope of the invention. Moreover, certain theories are proposed and disclosed herein; however, in no way they, whether they are right or wrong, should limit the scope of the invention so long as the invention is practiced according to the invention without regard for any particular theory or scheme of action.

### Example

### Screen-Printable Hexagonal Boron Nitride Ionogel Electrolytes for Mechanically Deformable Solid-State Lithium-Ion Batteries

Ionogel electrolytes present several benefits for solid-state lithium-ion batteries including nonflammability, favorable electrochemical properties, and high thermal stability. However, limited processing methods are currently available for ionogel electrolytes, which restricts their practical applications.

In this exemplary example, a screen-printable ionogel electrolyte formulation based on hexagonal boron nitride (hBN) nanoplatelets is disclosed. To achieve screen-printable rheological properties, hBN nanoplatelets are mixed with an imidazolium ionic liquid in ethyl lactate. Following screen printing, the resulting spatially uniform and mechanically flexible hBN ionogel electrolytes achieve high room-temperature ionic conductivities greater than 1 mS cm⁻¹ and stiff mechanical moduli greater than 1 MPa. These hBN ionogel electrolytes enable the fabrication of fully screen-printed lithium-ion batteries with high cycling stability, rate performance, and mechanical resilience against flexion and external forces, thus providing a robust energy storage solution that is compatible with scalable additive manufacturing.

### Methods

Exfoliation of hBN Nanoplatelets: hBN nanoplatelets were exfoliated from bulk hBN microparticles (≈1 μm, Sigma-Aldrich) using a solution-based exfoliation method. In a typical batch process, 120 g of bulk hBN microparticles, 12 g of ethyl cellulose (4 cP viscosity grade, Sigma-Aldrich), and 800 mL of ethanol were shear-mixed at 10,230 rpm for 2 h, using a rotor/stator mixer (L5M-A, Silverson) with a square hole screen. After centrifuging (J26-XPI, Beckman Coulter) the shear-mixed solution at 4,000 rpm for 20 min to sediment large particles, the supernatant was collected and mixed with an aqueous solution of 40 mg mL⁻¹ sodium chloride (16:9 by weight) to flocculate hBN nanoplatelets and ethyl cellulose. After centrifuging the mixture at 7,500 rpm for 6 min, the sedimented hBN nanoplatelets and ethyl cellulose were washed with deionized water to remove residual sodium chloride, dried overnight in a convection oven at 80° C., and annealed in a box furnace at 400° C. for 4 h to decompose ethyl cellulose.

Formulation of hBN Ionogel Electrolyte Inks: 1 M LiTFSI (99.95% trace metal basis, Sigma-Aldrich) was dissolved in EMIM-TFSI (H₂O≤500 ppm, Sigma-Aldrich) by stirring with a magnetic stir bar on a hotplate at 60° C. for 24 h. The exfoliated hBN nanoplatelets and EMIM-TFSI/1 M LiTFSI were mixed with ethyl lactate in a glass bottle, and the solution was agitated with a magnetic stir bar for 24 h. The ratio of the hBN nanoplatelets and EMIM-TFSI/1M LiTFSI was 1:2 by weight, and the concentration of the hBN ionogel electrolyte in ethyl lactate was 750 mg mL⁻¹.

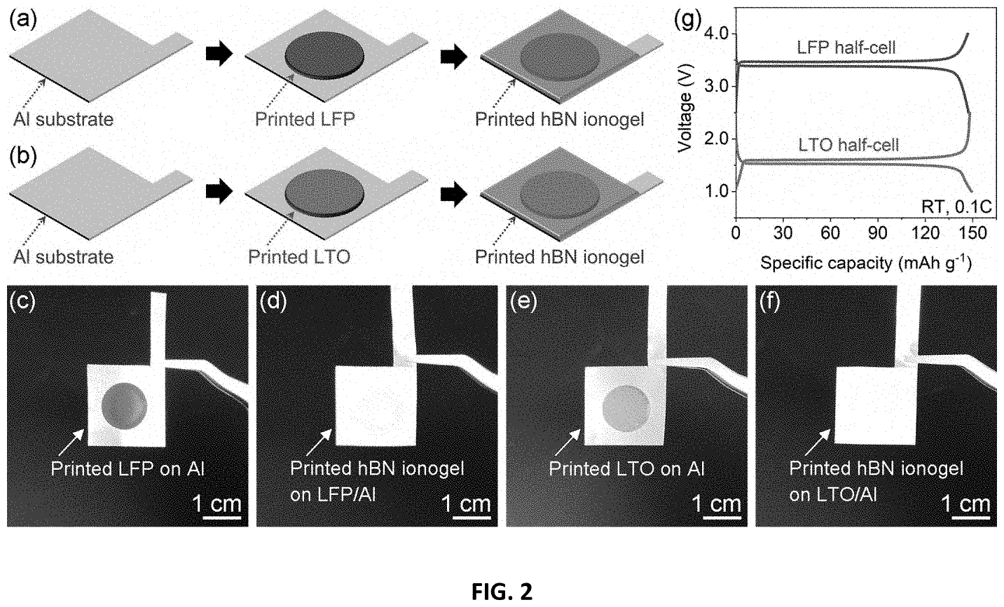

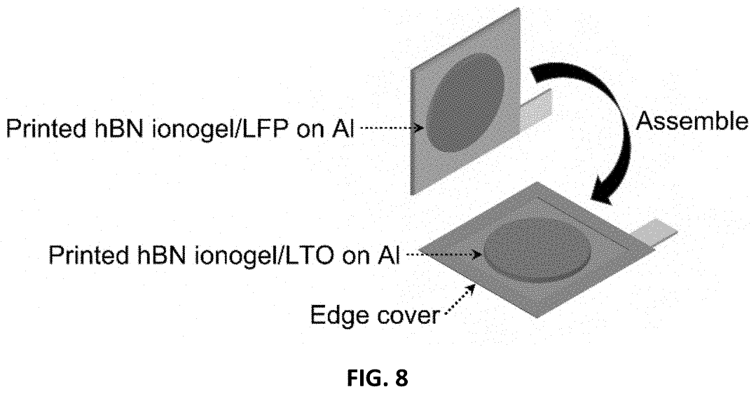

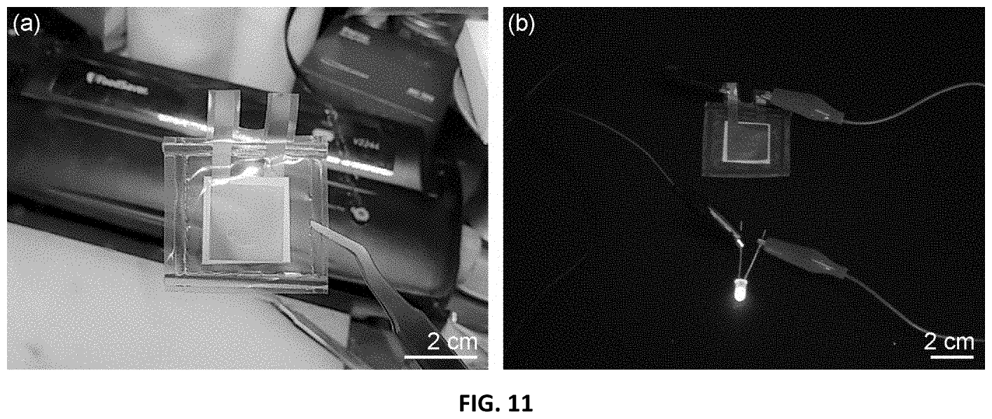

Battery Fabrication and Tests: To prepare electrode inks, active materials (LFP from MTI Corporation, LTO from Sigma-Aldrich), carbon black (MTI Corporation), and poly(vinylidene fluoride) (MTI Corporation) in a weight ratio of 8:1:1 were mixed with 1-methyl-2-pyrrolidinone. The concentration of the electrode materials in 1-methyl pyrrolidinone was 560 mg mL⁻¹ and 490 mg mL⁻¹ for the LFP and LTO inks, respectively. As shown in panels (a)-(b) of FIG. 2, the LFP and LTO inks were screen-printed with a circular pattern with a diameter of 1.2 cm on aluminum substrates, and dried in a vacuum oven at 80° C. for 24 h. On both the LFP and LTO electrodes, the hBN ionogel electrolyte ink was screen-printed with a square pattern of 2 cm×2 cm, followed by annealing on a hotplate at 160° C. for 30 min. Screen printing was manually performed using screens prepared with polyester meshes (Saatilene Hitex, mesh count: 43 cm⁻¹, thread diameter: 80 μm) and diazo emulsions (Ulano). Full-cells were assembled by sandwiching the printed LFP/ionogel and LTO/ionogel together in an argon-filled glovebox, as shown in FIG. 8. A thin film of an open square shape was inserted between the LFP/ionogel and LTO/ionogel to prevent contacts between the edges of the aluminum substrates. To promote interfacial contact between the LFP/ionogel and LTO/ionogel surfaces, a small amount (5 μL) of EMIM-TFSI/LiTFSI was drop-cast onto one surface before sandwiching. The rate and cycling performances were observed using a battery cycler (LBT-20084, Arbin) with CR2032 coin cell kits. Cycling tests were performed after two activation cycles at 0.2 C. For the mechanical tests, the printed batteries were packaged in plastic bags (FIG. 11), and a force gauge (FG-3008, Shimpo) was employed for precise control over applied forces.

Characterization: The hBN nanoplatelets were observed using a scanning electron microscope (SU8030, Hitachi). The XPS analysis of the hBN nanoplatelets was executed with an XPS instrument (ESCALAB 250Xi, Thermo Fisher Scientific) and the Thermo Scientific Avantage software. The Raman spectroscopy (XploRA PLUS, Horiba) of the hBN nanoplatelets was performed with a laser excitation wavelength of 532 nm, 100×objective, and grating of 1800 gr mm⁻¹. The viscosity of the hBN ionogel electrolyte and electrode inks was measured using a rheometer (MCR 302, Anton Paar) equipped with a 25 mm, 2° cone and plate geometry. Viscoelastic properties of the hBN ionogel electrolytes were characterized using the rheometer equipped with an 8 mm diameter parallel plate (gap between the rheometer stage and parallel plate: 1 mm) with a strain of 0.1%. The ionic conductivity (σ) of the hBN ionogel electrolyte was evaluated with a stainless-steel/ionogel/stainless-steel structure and the following equation:

$$σ = \frac{t}{R \times A}$$

where t and A are the thickness and area, respectively, of the hBN ionogel electrolyte between the stainless-steel electrodes, and R is the bulk resistance determined by electrochemical impedance spectroscopy employing a potentiostat (VSP, BioLogic) with a frequency range of 1 MHz-100 mHz and an amplitude of 10 mV. Temperature-controlled measurements were performed using an environmental chamber (BTX-475, Espec).

### Results and Discussion

The screen-printable ionogel electrolytes using exfoliated hexagonal boron nitride (hBN) nanoplatelets as the gelling matrix is obtained. In addition to hBN being electrically insulating, chemically inert, thermally stable, and mechanically robust, the nanoscale size and large surface area of exfoliated hBN enable strong immobilization of ionic liquids without significant disruption of ion conduction pathways, yielding hBN ionogel electrolytes with high mechanical strength and ionic conductivity. Screen-printable hBN ionogel electrolyte inks are prepared by dispersing hBN nanoplatelets and an imidazolium ionic liquid in ethyl lactate, enabling optimized viscosities for screen printing of spatially uniform and mechanically flexible solid-state electrolytes. Employing these hBN ionogel electrolyte inks, solid-state LIBs are screen-printed with LiFePO₄ (LFP) cathodes and Li₄Ti₅O₁₂ (LTO) anodes, exhibiting high rate performance and excellent cycling stability. Moreover, mechanical testing of the resulting screen-printed LIBs reveals outstanding stability against bending deformation and external forces, thus illustrating their suitability for mechanically flexible applications.

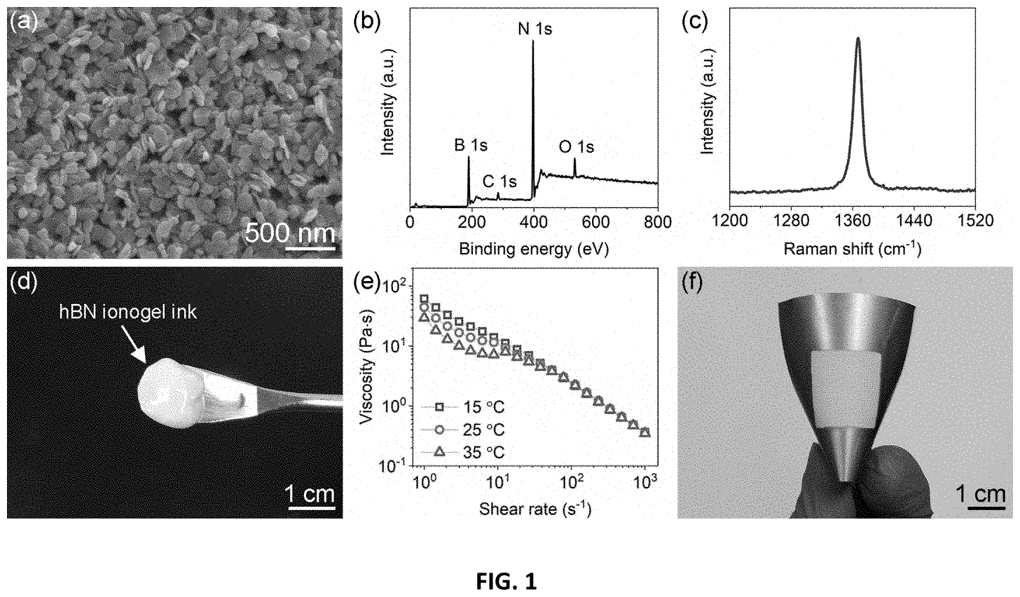

The hBN ionogel electrolytes are based on exfoliated hBN nanoplatelets, as shown in panel (a) of FIGS. 1, and 1-ethyl-3-methylimidazolium bis(trifluoromethylsulfonyl)imide (EMIM-TFSI) ionic liquids containing 1 M lithium bis(trifluoromethylsulfonyl)imide (LiTFSI) salt. The hBN nanoplatelets were obtained from bulk hBN microparticles using a previously reported solution-based exfoliation method. Panel (b) of FIG. 1 shows a survey X-ray photoelectron spectroscopy (XPS) spectrum, where the B 1s and N 1s peaks of the hBN nanoplatelets are evident at 189 eV and 397 eV, respectively. Additional low-intensity XPS peaks are observed for C 1s and O 1s because oxidized carbonaceous residues remain on the surface of the hBN nanoplatelets following pyrolysis of the stabilizing polymers used for the solution-based exfoliation method. These oxidized carbonaceous residues facilitate strong chemical interactions between the hBN nanoplatelets and the EMIM-TFSI ionic liquid, thus promoting strong gelation. Panel (c) of FIG. 1 displays a Raman spectrum of the hBN nanoplatelets with a characteristic peak at 1368 cm⁻¹, which is assigned to the B-N vibrational (E_{2g}) mode, as expected for hBN.

To formulate screen-printable inks, the hBN nanoplatelets and EMIM-TFSI/1 M LiTFSI were mixed in ethyl lactate. The ratio of the hBN nanoplatelets and EMIM-TFSI/1 M LiTFSI was 1:2 by weight, and the concentration of the hBN ionogel (i.e., hBN nanoplatelets and ionic liquid) in ethyl lactate was 750 mg mL⁻¹. Panel (d) of FIG. 1 shows a photograph of the hBN ionogel electrolyte ink. The ink viscosity shown in panel (e) of FIG. 1 was measured to be 10 Pa s at a shear rate of 10 s⁻¹ at 25° C. without a significant temperature dependence for ±10° C. Furthermore, the ink presented a shear thinning behavior with a power law index (n) of 0.35 and a consistency index (K) of 44 Pa s, according to the Ostwald-de Wæle model:

μ=Kγⁿ⁻¹

where μ and γ are the ink viscosity and shear rate, respectively. Shear thinning rheological properties are desirable for screen-printable inks because the decreased viscosity at high shear rates eases ink penetration through the screen mesh during the screen printing process.

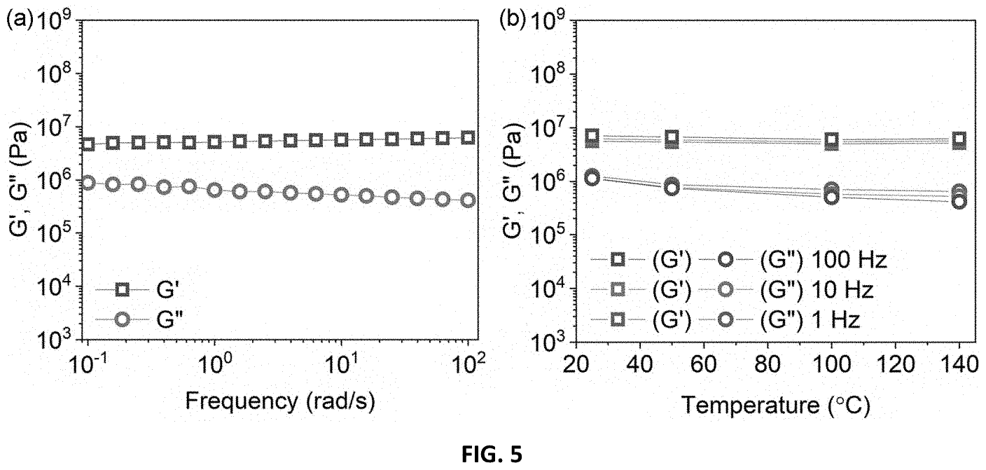

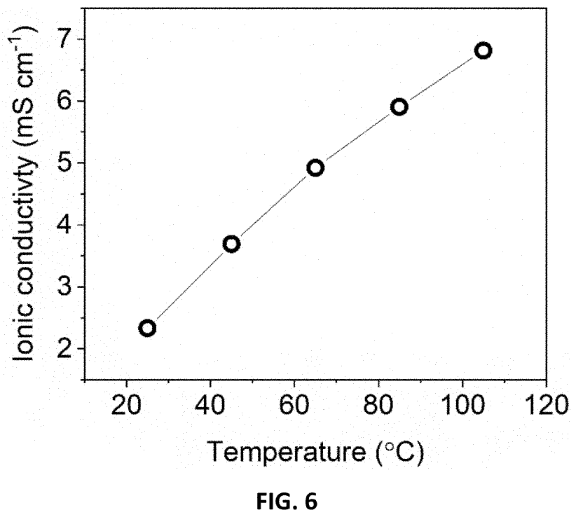

After screen printing, the substrates were annealed at 160° C. to remove ethyl lactate, generating spatially uniform and mechanically flexible hBN ionogel electrolytes, as shown in panel (f) of FIG. 1. The storage modulus (G′) of the hBN ionogel electrolytes was higher than the loss modulus (G″) with limited frequency and temperature dependence, as shown in FIG. 5, revealing reliable solid-like behavior. The hBN ionogel electrolytes also exhibited desirable mechanical moduli (G′) exceeding 1 MPa and high ionic conductivities exceeding 1 mS cm⁻¹ at room temperature, as shown in FIG. 6, suggesting their suitability for solid-state LIBs.

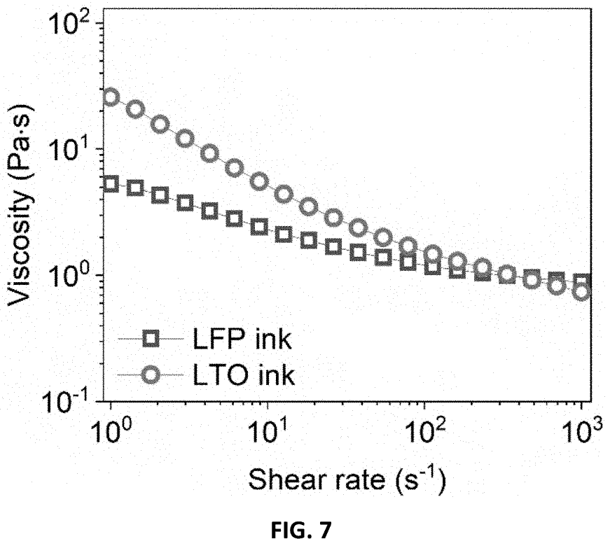

Panels (a)-(b) of FIG. 2 depict the screen printing fabrication process for solid-state LIBs using the hBN ionogel electrolytes. On an aluminum substrate, LFP is first screen-printed as the cathode, as shown in panel (c) of FIG. 2, and then the hBN ionogel electrolyte is screen-printed on top of the cathode, as shown in panel (d) of FIG. 2. On another aluminum substrate, LTO is first screen-printed as the anode, as shown in panel (e) of FIG. 2, and then the hBN ionogel electrolyte is screen-printed on top of the anode, as shown in panel (f) of FIG. 2. The LFP and LTO inks (FIG. 7) were prepared with the active materials, carbon black, and poly(vinylidene fluoride) in a weight ratio of 8:1:1, employing 1-methyl-2-pyrrolidinone as a solvent. The loading of both the printed cathode and anode electrodes was 5 mg cm⁻². In addition, the thickness of the hBN ionogel electrolytes on both the cathode and anode was 15 μm, which was sufficiently thick enough to uniformly cover the microporous electrodes, as shown in panels (d) and (f) of FIG. 2. Prior to the fabrication of LIB full-cells, LIB half-cells based on the screen-printed LFP/hBN ionogel and LTO/hBN ionogel samples were tested to evaluate the lithium-ion capacity of the screen-printed electrodes in combination with the screen-printed hBN ionogel electrolytes. As shown in panel (g) of FIG. 2, the specific discharge capacity was measured to be 147 mAh g⁻¹ and 149 mAh g⁻¹ at 0.1 C for the LFP and LTO half-cells, respectively. Furthermore, both the LFP and LTO half-cells exhibited typical charge-discharge voltage profiles with well-defined plateaus, revealing the effective electrochemical operation of the screen-printed electrodes and electrolytes.

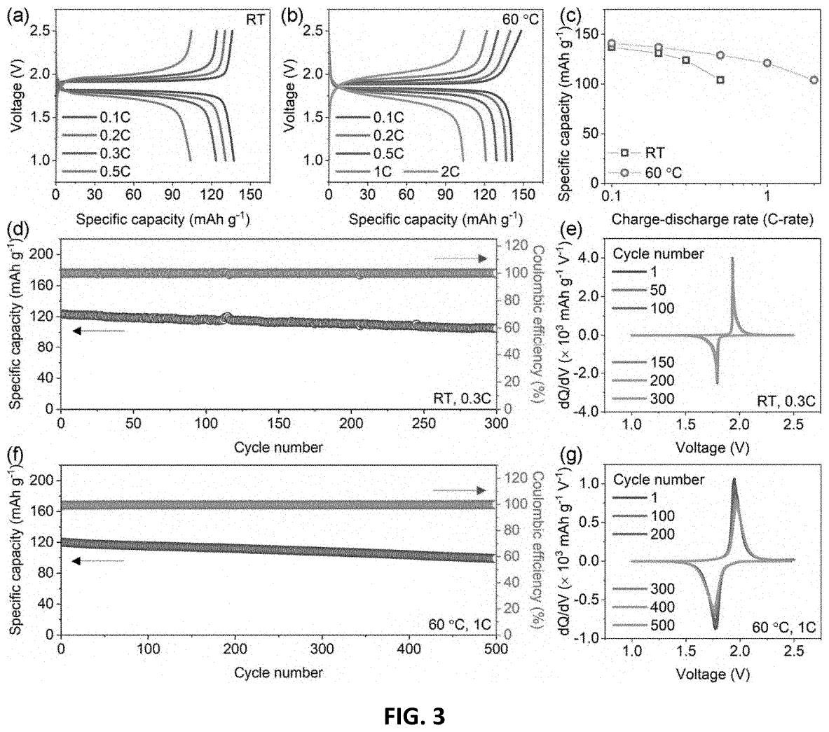

LFP/LTO full-cells were fabricated by sandwiching the screen-printed LFP/ionogel and LTO/ionogel, as shown in FIG. 8. Panels (a)-(b) of FIG. 3 display the charge-discharge voltage profiles of the LFP/LTO full-cells measured at room temperature and 60° C., respectively, with various charge-discharge rates. At room temperature, the specific discharge capacity of the LFP/LTO full-cell was 137 mAh g⁻¹ at 0.1 C, which remained higher than 100 mAh g⁻¹ at rates up to 0.5 C. This favorable rate performance for a solid-state LIB can be attributed to the high room-temperature ionic conductivity of the hBN ionogel electrolytes. In addition, the specific discharge capacity at 60° C. was 141 mAh g⁻¹ at 0.1 C, which remained higher than 100 mAh g⁻¹ at rates up to 2 C. The improved rate capability at 60° C. compared to room temperature, as shown in panel (c) of FIG. 3, originates from the improved ionic conductivity of the hBN ionogel electrolytes at elevated temperatures, as shown in FIG. 6.

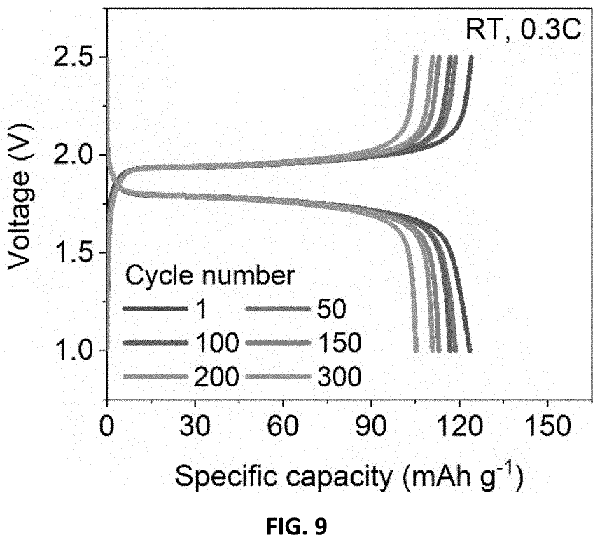

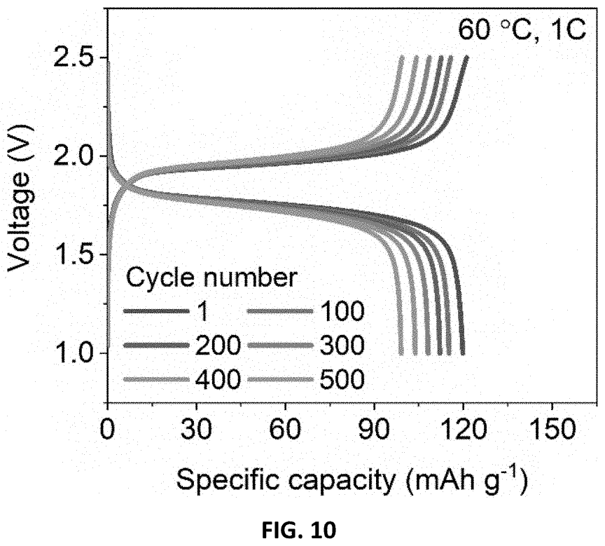

The cycling performance of the screen-printed LFP/LTO full-cells was also evaluated at room temperature and 60° C. Panel (d) of FIG. 3 displays the specific discharge capacity and Coulombic efficiency for 300 cycles at 0.3 C at room temperature, as shown in FIG. 9. The initial discharge capacity was 124 mAh g⁻¹, and greater than 85% of the initial capacity was retained after 300 cycles, which is equivalent to a capacity loss of less than 0.05% per cycle. In addition, the average Coulombic efficiency for the 300 cycles exceeded 99.9%. Panel (e) of FIG. 3 shows differential capacity curves of the printed LFP/LTO battery up to 300 cycles, where the peaks at 1.94 V and 1.74 V are associated with the voltage plateaus for charging and discharging, respectively. The two major peaks showed minimal shifting during the cycling test, which implies negligible changes in the LIB operating voltage and provides additional evidence of the outstanding cycling stability of screen-printed LIBs based on hBN ionogel electrolytes. Moreover, Panel (f) of FIG. 3 presents the specific discharge capacity and Coulombic efficiency of the screen-printed LFP/LTO full-cell for 500 cycles at 60° C. and 1 C rate, as shown in FIG. 10. The initial discharge capacity was 120 mAh g⁻¹, and >82% of the initial capacity was retained after 500 cycles, which is equivalent to a capacity loss of less than 0.04% per cycle. In addition, the average Coulombic efficiency for this 500-cycle test exceeded 99.5%. Similar to the room-temperature results, the differential capacity curves at 60° C., as shown in panel (g) of FIG. 3, presented minimal peak shifting for both the charging and discharging processes. Overall, the electrochemical characterization showed excellent cycling stability of the screen-printed LIBs both at room temperature and at elevated temperatures.

Table 1 lists comparisons of the electrochemical performance of the screen-printed LFP/LTO full-cells based on the hBN ionogel electrolyte of the invention with literature precedent, revealing superior performance compared to previous printed LIBs using LFP and LTO electrodes in combination with other ionogel electrolytes. In particular, whereas previously reported printed LIBs have typically only been tested at low rates near 0.1 C at room temperature, the screen-printed LFP/LTO full-cells based on the hBN ionogel electrolytes exhibited favorable capacity at higher rates up to 0.5 C at room temperature in addition to even higher rate performance up to 2 C at 60° C. Furthermore, the printed LFP/LTO full-cells based on the hBN ionogel electrolytes showed significantly improved cycle life in comparison to previously reported printed LFP/LTO full-cells. This unprecedented electrochemical performance can be attributed to the high ionic conductivity and electrochemical stability of the hBN ionogel electrolytes.

TABLE 1
Comparison to previously reported printed LIBs based on ionogel electrolytes.

| | Reference [32] | Reference [33] | This Invention |
|---|---|---|---|
| Ionogel | SiO₂-based | Polymer-based | hBN-based |
| Printing method | Inkjet printing | 3D printing | Screen printing |
| Cathode/anode | LFP/LTO | LFO/LTO | LFP/LTO |
| Electrode loading | 0.8 mg cm⁻² | 4.2-4.6 mg cm⁻² | 5 mg cm⁻² |
| Measured specific | 60 mAh g⁻¹ at 0.1 C | 112 mAh g⁻¹ at 0.09 C | 137 mAh g⁻¹ at 0.1 C |
| capacity | at room temperature | at room temperature | 131 mAh g⁻¹ at 0.2 C |
| | | | 124 mAh g⁻¹ at 0.3 C |
| | | | 104 mAh g⁻¹ at 0.5 C |
| | | | at room temperature |
| | | | 141 mAh g⁻¹ at 0.1 C |
| | | | 137 mAh g⁻¹ at 0.2 C |
| | | | 129 mAh g⁻¹ at 0.5 C |
| | | | 121 mAh g⁻¹ at 1 C |
| | | | 104 mAh g⁻¹ at 2 C |
| | | | at 60° C. |
| Number of tested | 100 cycles | 2 cycles | 300 cycles |
| cycles at room | (86%) | (85%) | (85%) |
| temperature | | | |
| (capacity | | | |
| retention) | | | |

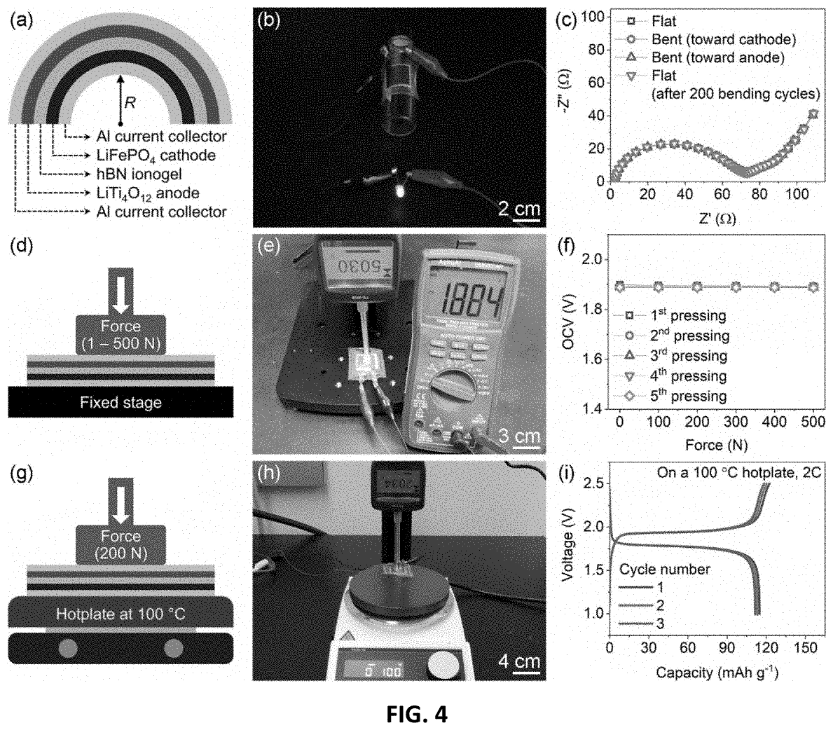

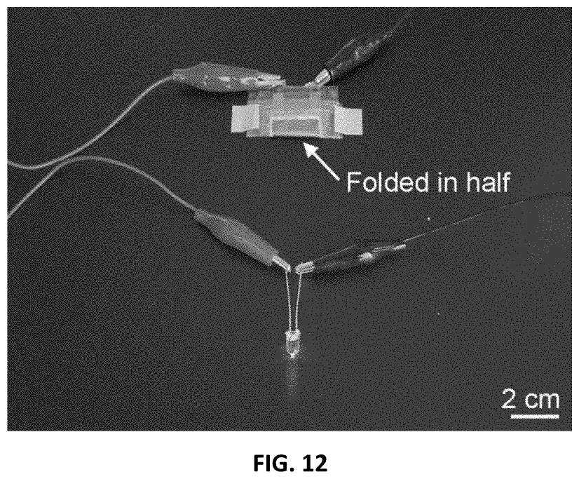

The mechanically deformable nature of the hBN ionogel electrolytes presents additional opportunities for mechanically flexible energy storage applications. To demonstrate the mechanical flexibility of the screen-printed LFP/LTO full-cells based on the hBN ionogel electrolytes, bending tests, as shown in panels (a)-(b) of FIG. 4, were performed after packaging the screen-printed LIBs in sealed plastic bags, as shown in FIG. 11. The bending tests of the screen-printed LFP/LTO full-cells, where the screen-printed LIBs were repeatedly bent toward the cathode and anode while being connected to light-emitting diodes (LEDs), show that the screen-printed LIBs maintain constant power for the LEDs without any observable changes in the LED brightness during repeated bending, thus revealing outstanding bending tolerance regardless of the bending direction. In addition, the bending stability was further confirmed by performing electrochemical impedance spectroscopy analysis during the bending tests. Panel (c) of FIG. 4 displays Nyquist plots of the screen-printed LIBs before and during bending, and also after 200 bending cycles (i.e., 100 bending cycles toward the cathode and 100 bending cycles toward the anode) with a bending radius of 14 mm. The negligible change of the Nyquist plots implies that the hBN ionogel electrolytes allow stable bending deformation without compromising the interfaces between the screen-printed layers. Moreover, the screen-printed LIBs were functional even after folding in half, as shown in FIG. 12.

In addition to high stability during mechanical deformation, the high mechanical modulus of the hBN ionogel electrolytes provides resilience in the presence of external forces. This attribute is important since mechanically flexible LIBs are not packaged in hard cases that provide mechanical protection. Furthermore, compared to conventional liquid electrolytes used in combination with membrane separators, the hBN ionogel electrolyte serves as both an ion conductor and a separator. Hence, their mechanical strength is crucial to maintain the separation of the cathode and anode electrodes and thereby avoid short circuits in the presence of external forces. To demonstrate this resilience, pressing tests were performed for the screen-printed LFP/LTO full-cells, as shown in panel (d) of FIG. 4, where compressive forces were applied while the open-circuit voltage (OCV) was monitored, as shown in panel (e) of FIG. 4. The compressive forces were gradually raised to 500 N, which corresponds to a pressure of 4.5 MPa with a contact area of 1.1 cm². As shown in panel (f) of FIG. 4, the screen-printed LIBs did not exhibit any signs of failure or significant changes in OCV, implying that the hBN ionogel electrolytes withstood the high pressure and thus inhibited the external forces from forming short circuits between the cathode and anode electrodes. Repeated application of these compressive forces (panel (f) of FIG. 4) also did not result in noticeable changes in OCV, further verifying high resilience against external forces.

The hBN ionogel electrolytes maintain their high mechanical moduli exceeding 1 MPa to temperatures as high as 140° C., as shown in FIG. 5. This temperature invariance of the hBN ionogel mechanical strength suggests that screen-printed LIBs will retain their outstanding mechanical stability for high-temperature applications. To confirm this high-temperature mechanical stability, pressing tests were repeated while heating the screen-printed LFP/LTO full-cells, as shown in panels (g)-(h) of FIG. 4. In this case, a compressive force of 200 N (pressure of 1.8 MPa with a contact area of 1.1 cm²) was applied to the screen-printed LIB on a hotplate at 100° C. Panel (i) of FIG. 4 displays the resulting charge-discharge voltage profiles at a rate of 2 C, revealing normal LIB operation without voltage instabilities.

In summary, the screen-printable hBN ionogel electrolytes that are suitable for mechanically deformable solid-state LIBs were developed. Screen-printable hBN ionogel electrolyte inks were formulated by mixing solution-exfoliated hBN nanoplatelets, EMIM-TFSI/1 M LiTFSI, and ethyl lactate, resulting in a viscosity of 10 Pa s at a shear rate of 10 s⁻¹ with shear thinning behavior. These inks enable screen printing of spatially uniform and mechanically flexible hBN ionogel electrolytes that possess high room-temperature ionic conductivities greater than 1 mS cm⁻¹ and stiff mechanical moduli greater than 1 MPa. Using the hBN ionogel electrolytes, screen-printed LIBs were fabricated with LFP cathode and LTO anode electrodes that exhibited desirable rate performance and cycling stability at both room and elevated temperatures. Furthermore, bending and pressing tests revealed outstanding mechanical resilience of the screen-printed LIBs against bending deformation and external compressive forces, which can be ascribed to the high mechanical flexibility and strength of the hBN ionogel electrolytes. Overall, this work establishes screen-printable hBN ionogel electrolytes as enabling materials for mechanically deformable solid-state LIB technologies.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

Some references, which may include patents, patent applications and various publications, are cited and discussed in the description of this invention. The citation and/or discussion of such references is provided merely to clarify the description of the present invention and is not an admission that any such reference is “prior art” to the invention described herein. All references cited and discussed in this specification are incorporated herein by reference in their entireties and to the same extent as if each reference was individually incorporated by reference.

### LIST OF REFERENCES

[1]. Tan, D. H. S.; Banerjee, A.; Chen, Z.; Meng, Y. S. From nanoscale interface characterization to sustainable energy storage using all-solid-state batteries. Nat. Nanotechnol. 2020, 15, 170-180.
[2]. Manthiram, A.; Yu, X.; Wang, S. Lithium battery chemistries enabled by solid-state electrolytes. Nat. Rev. Mater. 2017, 2, 16103.
[3]. Hyun, W. J.; Thomas, C. M.; Hersam, M. C. Nanocomposite ionogel electrolytes for solid-state rechargeable batteries. Adv. Energy Mater. 2020, 10, 2002135.
[4]. Chen, N.; Zhang, H.; Li, L.; Chen, R.; Guo, S. Ionogel electrolytes for high-performance lithium batteries: A review. Adv. Energy Mater. 2018, 8, 1702675.
[5]. Chen, X.; Put, B.; Sagara, A.; Gandrud, K.; Murata, M.; Steele, J. A.; Yabe, H.; Hantschel, T.; Roeffaers, M.; Tomiyama, M.; Arase, H.; Kaneko, Y.; Shimada, M.; Mees, M.; Vereecken, P. M. Silica gel solid nanocomposite electrolytes with interfacial conductivity promotion exceeding the bulk Li-ion conductivity of the ionic liquid electrolyte filler. Sci. Adv. 2020, 6, eaav3400.
[6]. Hyun, W. J.; Thomas, C. M.; Luu, N. S.; Hersam, M. C. Layered heterostructure ionogel electrolytes for high-performance solid-state lithium-ion batteries. Adv. Mater. 2021, 33, 2007864.
[7]. Rodrigues, M. T. F.; Kalaga, K.; Gullapalli, H.; Babu, G.; Reddy, A. L. M.; Ajayan, P. M. Hexagonal boron nitride-based electrolyte composite for Li-ion battery operation from room temperature to 150° C. Adv. Energy Mater. 2016, 6, 1600218.
[8]. Taylor, M. E.; Clarkson, D.; Greenbaum, S. G.; Panzer, M. J. Examining the impact of polyzwitterion chemistry on lithium ion transport in ionogel electrolytes. ACS Appl. Polym. Mater. 2021, 3, 2635-2645.
[9]. Wang, Z.; Tan, R.; Wang, H.; Yang, L.; Hu, J.; Chen, H.; Pan, F. A metal-organic-framework-based electrolyte with nanowetted interfaces for high-energy-density solid-state lithium battery. Adv. Mater. 2018, 30, 1704436.
[10]. Gaikwad, A. M.; Arias, A. C.; Steingart, D. A. Recent progress on printed flexible batteries: Mechanical challenges, printing technologies, and future prospects. Energy Technol. 2015, 3, 305-328.
[11]. Costa, C.; Gonsalves, R.; Lanceros-Mendez, S. Recent advances and future challenges in printed batteries. Energy Storage Mater. 2020, 28, 216-234.
[12]. Thomas, C. M.; Hyun, W. J.; Huang, H. C.; Zeng, D.; Hersam, M. C. Blade-coatable hexagonal boron nitride ionogel electrolytes for scalable production of lithium metal batteries. ACS Energy Lett. 2022, 7, 1558-1565.
[13]. Lawes, S.; Sun, Q.; Lushington, A.; Xiao, B.; Liu, Y.; Sun, X. Inkjet-printed silicon as high performance anodes for Li-ion batteries. Nano Energy 2017, 36, 313-321.
[14]. Gu, Y.; Wu, A.; Sohn, H.; Nicoletti, C.; Iqbal, Z.; Federici, J. F. Fabrication of rechargeable lithium ion batteries using water-based inkjet printed cathodes. J. Manuf. Process. 2015, 20, 198-205.
[15]. Wei, T. S.; Ahn, B. Y.; Grotto, J.; Lewis, J. A. 3D printing of customized Li-ion batteries with thick electrodes. Adv. Mater. 2018, 30, 1703027.
[16]. Reyes, C.; Somogyi, R.; Niu, S.; Cruz, M. A.; Yang, F.; Catenacci, M. J.; Rhodes, C. P.; Wiley, B. J. Three-dimensional printing of a complete lithium ion battery with fused filament fabrication. ACS Appl. Energy Mater. 2018, 1, 5268-5279.
[17]. Deiner, L. J.; Jenkins, T.; Powell, A.; Howell, T.; Rottmayer, M. High capacity rate capable aerosol jet printed Li-ion battery cathode. Adv. Eng. Mater. 2019, 21, 1801281.
[18]. Sousa, R.; Oliveira, J.; Gören, A.; Miranda, D.; Silva, M. M.; Hilliou, L.; Costa, C.; Lanceros-Mendez, S. High performance screen printable lithium-ion battery cathode ink based on C—LiFePO₄. Electrochim. Acta 2016, 196, 92-100.
[19]. Hyun, W. J.; Secor, E. B.; Hersam, M. C.; Frisbie, C. D.; Francis, L. F. High-resolution patterning of graphene by screen printing with a silicon stencil for highly flexible printed electronics. Adv. Mater. 2015, 27, 109-115.
[20]. Ohta, S.; Komagata, S.; Seki, J.; Saeki, T.; Morishita, S.; Asaoka, T. All-solid-state lithium ion battery using garnet-type oxide and Li₃Bₒ₃ solid electrolytes fabricated by screen-printing. J. Power Sources 2013, 238, 53-56.
[21]. El Baradai, 0.; Beneventi, D.; Alloin, F.; Bultel, Y.; Chaussy, D. Use of cellulose nanofibers as an electrode binder for lithium ion battery screen printing on a paper separator. Nanomaterials 2018, 8, 982.
[22]. El Baradai, 0.; Beneventi, D.; Alloin, F.; Bongiovanni, R.; Bruas-Reverdy, N.; Bultel, Y.; Chaussy, D. Microfibrillated cellulose based ink for eco-sustainable screen printed flexible electrodes in lithium ion batteries. J. Mater. Sci. Technol. 2016, 32, 566-572.
[23]. Park, M.-S.; Hyun, S.-H.; Nam, S.-C. Mechanical and electrical properties of a LiCoO₂ cathode prepared by screen-printing for a lithium-ion micro-battery. Electrochim. Acta 2007, 52, 7895-7902.
[24]. Kang, K.-Y.; Lee, Y.-G.; Shin, D. O.; Kim, J.-C.; Kim, K. M. Performance improvements of pouch-type flexible thin-film lithium-ion batteries by modifying sequential screen-printing process. Electrochim. Acta 2014, 138, 294-301.
[25]. Yu, S.; Mertens, A.; Tempel, H.; Schierholz, R.; Kungl, H.; Eichel, R.-A. Monolithic all-phosphate solid-state lithium-ion battery with improved interfacial compatibility. ACS Appl. Mater. Interfaces 2018, 10, 22264-22277.
[26]. Hyun, W. J.; De Moraes, A. C.; Lim, J.-M.; Downing, J. R.; Park, K.-Y.; Tan, M. T. Z.; Hersam, M. C. High-modulus hexagonal boron nitride nanoplatelet gel electrolytes for solid-state rechargeable lithium-ion batteries. ACS Nano 2019, 13, 9664-9672.
[27]. Song, L.; Ci, L.; Lu, H.; Sorokin, P. B.; Jin, C.; Ni, J.; Kvashnin, A. G.; Kvashnin, D. G.; Lou, J.; Yakobson, B. I.; Ajayan, P. M. Large scale growth and characterization of atomic hexagonal boron nitride layers. Nano Lett. 2010, 10, 3209-3215.
[28]. Shi, Y.; Hamsen, C.; Jia, X.; Kim, K. K.; Reina, A.; Hofmann, M.; Hsu, A. L.; Zhang, K.;

Li, H.; Juang, Z.-Y.; Dresselhaus, M. S.; Li, L.-J.; Kong, J. Synthesis of few-layer hexagonal boron nitride thin film by chemical vapor deposition. Nano Lett. 2010, 10, 4134-4139.
[29]. Gorbachev, R. V.; Riaz, I.; Nair, R. R.; Jalil, R.; Britnell, L.; Belle, B. D.; Hill, E. W.; Novoselov, K. S.; Watanabe, K.; Taniguchi, T.; Geim, A. K.; Blake, P. Hunting for monolayer boron nitride: Optical and raman signatures. Small 2011, 7, 465-468.
[30]. Ye, H.; Lu, T.; Xu, C.; Han, B.; Meng, N.; Xu, L. Liquid-phase exfoliation of hexagonal boron nitride into boron nitride nanosheets in common organic solvents with hyperbranched polyethylene as stabilizer. Macromol. Chem. Phys. 2018, 219, 1700482.
[31]. Taroni, M.; Breward, C. J. W.; Howell, P. D.; Oliver, J. M.; Young, R. J. S. The screen printing of a power-law fluid. J. Eng. Math. 2012, 73, 93-119.
[32]. Hyun, W. J.; Lim, S.; Ahn, B. Y.; Lewis, J. A.; Frisbie, C. D.; Francis, L. F. Screen printing of highly loaded silver inks on plastic substrates using silicon stencils. ACS Appl. Mater. Interfaces 2015, 7, 12619-12624.
[33]. Delannoy, P.-E.; Riou, B.; Lestriez, B.; Guyomard, D.; Brousse, T.; Le Bideau, J. Toward fast and cost-effective ink-jet printing of solid electrolyte for lithium microbatteries. J. Power Sources 2015, 274, 1085-1090.
[34]. Cheng, M.; Jiang, Y.; Yao, W.; Yuan, Y.; Deivanayagam, R.; Foroozan, T.; Huang, Z.; Song, B.; Rojaee, R.; Shokuhfar, T.; Pan, Y.; Lu, J.; Shahbazian-Yassar, R. Elevated-temperature 3D printing of hybrid solid-state electrolyte for Li-ion batteries. Adv. Mater. 2018, 30, 1800615.
[35]. Gaikwad, A. M.; Chu, H. N.; Qeraj, R.; Zamarayeva, A. M.; Steingart, D. A. Reinforced electrode architecture for a flexible battery with paperlike characteristics. Energy Technol. 2013, 1, 177-185.
[36]. Frisbie, C. D.; Lodge, T.; Ion gels and electronic devices utilizing ion gels, WO2008/097300A3, 2008.
[37]. White, S. P.; Frisbie, C. D.; Dorfman, K. D.; Electrolyte-gated transistors for detection of molecules, WO2016/025743, 2016.
[38]. Liu, A.; Gleason, K. K.; Wang, M.; Vapor-deposited nanoscale ionic liquid gels as gate insulators for low-voltage high-speed thin film transistors, US2019/0131554 A1, 2019.
[39]. Wright, P. K.; Evans, J. W.; Ho, C.; Ionic gel electrolyte, energy storage devices, and methods of manufacture thereof, US2018/0226680 A1, 2018.
[40]. Rajiv R. Singh R. R.; Paonessa, M. R.; Shankland, I. R.; Polymer ionic electrolytes (2011), U.S. Pat. No. 7,955,738 B2, 2011.

What is claimed is:

1. An ionogel electrolyte ink, comprising:
an ionic liquid; and
a gelling matrix material,
wherein the gelling matrix material is mixed with the ionic liquid in at least one solvent.

2. The ionogel electrolyte ink of claim 1, wherein a ratio of the gelling matrix material to the ionic liquid is about 1:2 by weight.

3. The ionogel electrolyte ink of claim 2, wherein a concentration of the gelling matrix material and the ionic liquid in the at least one solvent is about 600-900 mg mL⁻¹.

4. The ionogel electrolyte ink of claim 1, having a viscosity that is tunable by a shear rate, wherein the ink viscosity decreases as the shear rate increases.

5. The ionogel electrolyte ink of claim 4, wherein the ink viscosity and the shear rate satisfy the relation of:
μ=Kγⁿ⁻¹
wherein μ and γ are the ink viscosity and the shear rate, respectively, n is a power law index of about 0.35, and K is a consistency index of about 44 Pa.

6. The ionogel electrolyte ink of claim 1, having a storage modulus (G′) that is higher than its loss modulus (G″) with limited frequency and temperature dependence, revealing the reliable solid-like behavior of the ionogel electrolyte ink.

7. The ionogel electrolyte ink of claim 6, having a mechanical moduli (G′) exceeding 1 MPa, and high ionic conductivities exceeding 1 mS cm⁻¹ at room temperature.

8. The printable ionogel ink of claim 1, having ionic conductivity that increases with temperature.

9. The ionogel electrolyte ink of claim 1, wherein the ionic liquid comprises 1-ethyl-3-methylimidazolium bis(trifluoromethylsulfonyl)imide (EMIM-TFSI), ammonium, imidazolium, pyrrolidinium, pyridinium, piperidinium, phosphonium, sulfonium-based ionic liquids, or a combination of them.

10. The ionogel electrolyte ink of claim 9, wherein the ionic liquid comprises 1-ethyl-3-methylimidazolium bis(trifluoromethylsulfonyl)imide (EMIM-TFSI).

11. The ionogel electrolyte ink of claim 10, wherein said EMIM-TFSI contains lithium bis(trifluoromethylsulfonyl)imide (LiTFSI) salt.

12. The ionogel electrolyte ink of claim 1, wherein the gelling matrix material comprises boron nitride nanosheets (BNNS), borocarbonitrides (BCN), oxide nanosheets, layered perovskites, hydroxide nanosheets including hydrotalcite-like layered double hydroxides, natural clays including bentonites and montmorillonites, or a combination of them.

13. The ionogel electrolyte ink of claim 12, wherein the BNNS comprises hexagonal boron nitride (hBN) nanoplatelets that are formed from bulk hBN microparticles by a liquid-phase exfoliation method.

14. The ionogel electrolyte ink of claim 13, wherein each exfoliated hBN nanoplatelet is coated with a thin amorphous carbon coating.

15. The ionogel electrolyte ink of claim 13, wherein the surface of each hBN nanoplatelet has oxidized carbonaceous residues following pyrolysis of stabilizing polymers by the liquid-phase exfoliation method, wherein the oxidized carbonaceous residues facilitate strong chemical interactions between the hBN nanoplatelets and the ionic liquid, thereby promoting strong gelation.

16. The ionogel electrolyte ink of claim 12, wherein the oxide nanosheets comprises Al₂O₃, TiO₂ (anatase and rutile), ZrO₂, Nb₂O₅, HfO₂, CaCu₃Ti₄O₁₂, Pb(Zr,Ti)O₃, (Pb,La)(Zr,Ti)O₃, SiO₂, Al₂O₃, HfSiO₄, ZrO₂, HfO₂, Ta₂O₅, La₂O₃, LaAlO₃, Nb₂O₅, BaTiO₃, SrTiO₃, Ta₂O₅, or a combination of them.

17. The ionogel electrolyte ink of claim 1, wherein the at least one solvent comprises a single solvent including ethyl lactate, cyclohexanone, terpineol, ethylene glycol, ethanol, isopropanol, or butanone.

18. The ionogel electrolyte ink of claim 1, being a screen-printable ionogel electrolyte ink.

19. A electrochemical device, comprising:
at least one component formed of the ionogel electrolyte ink of claim 1.

20. The electrochemical device of claim 19, being one or more batteries, one or more supercapacitors, one or more transistors, one or more neuromorphic computing devices, one or more flexible electronics, one or more printed electronics, or any combination of them.

21. The electrochemical device of claim 19, further comprising:
a cathode, and an anode,
wherein the at least one component is disposed between the cathode and the anode, wherein the at least one component comprises one or more ionogel electrolytes that are screen-printed of the ionogel electrolyte ink.

22. The electrochemical device of claim 21, being a solid-state lithium-ion battery (LIB).

23. The electrochemical device of claim 22, wherein the cathode comprises lithium nickel manganese cobalt oxides, lithium iron phosphate, lithium cobalt oxide, lithium nickel cobalt aluminum oxides, lithium manganese oxide, lithium nickel manganese oxide, lithium nickel oxide, or other electrochemically active cathode materials, and wherein the anode comprises graphite, lithium titanate, Li₂TiSiO₅, silicon, germanium, tin, lithium metal, or other electrochemically active anode materials.

24. The electrochemical device of claim 23, wherein
the cathode comprises LiFePO₄ (LFP) screen-printed of an LEP ink on a first substrate;
the anode comprises LTO screen-printed of an LTO ink on a second substrate;
the one or more ionogel electrolytes comprise a first hBN ionogel electrolyte screen-printed on a top of the cathode to define a screen-printed LEP/ionogel structure, and a second hBN ionogel electrolyte screen-printed on a top of the anode to define a screen-printed LTO/ionogel structure; and
the LIB is fabricated by sandwiching the screen-printed LFP/ionogel structure and the screen-printed LTO/ionogel structure.

25. The electrochemical device of claim 24, wherein each of the LFP ink and the LTO ink comprises the active material of LFP or LTO, carbon black, and poly(vinylidene fluoride) dispersed in a solvent of 1-methyl-2-pyrrolidinone.

26. The electrochemical device of claim 24, wherein each of the first and second hBN ionogel electrolytes has a thickness of 15 μm or larger.

27. The electrochemical device of claim 24, wherein the LIB has a specific discharge capacity of 137 mAh g⁻¹ at 0.1 C, which remains higher than 100 mAh g⁻¹ at rates up to 0.5 C, at room temperature.

28. The electrochemical device of claim 24, wherein the LIB has a specific discharge capacity of 141 mAh g⁻¹ at 0.1 C, which remains higher than 100 mAh g⁻¹ at rates up to 2 C, at about 60° C.

29. The electrochemical device of claim 24, wherein the LIB has a capacity loss being less than 0.05% of an initial capacity per cycle for 300 cycles, and an average Coulombic efficiency for the 300 cycles exceeding 99.9%, at room temperature.

30. The electrochemical device of claim 24, wherein the LIB has a capacity loss being less than 0.04% of an initial capacity per cycle for 500 cycles, and the average Coulombic efficiency for the 500 cycles exceeding 99.5%, at about 60° C.

31. The electrochemical device of claim 24, wherein the LIB has mechanically deformable, bendable and/or flexible.

32. The electrochemical device of claim 25, wherein the LIB maintains constant power output during repeated bending of the LIB regardless of the bending direction.

33. The electrochemical device of claim 25, wherein the LIB has Nyquist plots with negligible or no change before, during and after bending, thereby implying that the hBN ionogel electrolytes allow stable bending deformation without compromising the interfaces between the screen-printed layers.

34. The electrochemical device of claim 25, wherein the hBN ionogel electrolytes have the high mechanical modulus that provides resilience in the presence of external forces.

35. The electrochemical device of claim 34, wherein the LIB exhibits no signs of failure or no noticeable changes in an open-circuit voltage (OCV) when a compressive force applied to the LIB is gradually raised to 500 N, thereby implying that the hBN ionogel electrolytes withstood the high pressure and thus inhibit the external forces from forming short circuits between the cathode and anode electrodes.

36. The electrochemical device of claim 34, wherein the hBN ionogel electrolytes maintain the high mechanical moduli exceeding 1 MPa to temperatures as high as about 140° C.

37. The electrochemical device of claim 34, wherein the LIB operates normally without voltage instabilities when a compressive force of 200 N is applied to the LIB on a hotplate at about 100° C.
